(19) United States
(12) Patent Application Publication
(10) Pub. No.: US 2025/0057323 A1
(43) Pub. Date: Feb. 20, 2025

(54) NO-SLIP SHEET GRIP

(71) Applicant: Christina Cano, coconut creek, FL (US)

(72) Inventor: Christina Cano, coconut creek, FL (US)

(21) Appl. No.: 18/234,098

(22) Filed: Aug. 15, 2023

(51) Int. Cl. A47C 21/02; B32B 1/00; B32B 27/06

(52) U.S. Cl. CPC A47C 21/022; B32B 1/00; B32B 27/06; B32B 2307/744; B32B 2479/00

(57) ABSTRACT

A sheet grip may be constructed and arranged to prevent sheets from slipping off mattress corners. The sheet grip may include a base including a friction generating layer at least partially surround the base. The sheet grip may include a wall including a friction generating layer at least partially surround the wall. The friction generating layers may be constructed and arranged to prevent sheets from slipping off mattress corners.

### TECHNICAL FIELD

The embodiments generally relate to bedding products.

### BACKGROUND

Bedding may include elastic-trimmed sheets that commonly slip off mattress corners.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

A sheet grip may include a generally circular sector shaped base including a first base surface opposite a second base surface. A first friction layer including a friction generating material may be disposed on the first base surface. A second friction layer including a friction generating material may be disposed on the second base surface. A generally curved wall may be fixed to the base, the generally curved wall including a first wall surface opposite a second wall surface. A third friction layer including a friction generating material may be disposed on the first wall surface. A fourth friction layer may include a friction generating material disposed on the second wall surface.

The sheet grip may be constructed and arranged to prevent elastic-trimmed sheets from slipping off mattress corners.

Other illustrative variations within the scope of the invention will become apparent from the detailed description provided hereinafter. The detailed description and enumerated variations, while disclosing optional variations, are intended for purposes of illustration only and are not intended to limit the scope of the invention

### DETAILED DESCRIPTION

The specific details of the single embodiment or variety of embodiments described herein are to the described product and methods of use. Any specific details of the embodiments are used for demonstration purposes only and no unnecessary limitations or inferences are to be understood from there.

It is noted that the embodiments reside primarily in combinations of components and procedures related to the product. Accordingly, the product components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed sheet grip may include base substrate and a wall. The base may be generally circular sector shaped. The wall may be generally arc-shaped and may be joined to the base at an arc of the circular sector-shaped base. According to some embodiments, the base and wall may be made of plastic, such as a rigid or semi-rigid plastic.

A flexible, high friction-producing material may be disposed on a top surface and bottom surface of the base and an interior surface and exterior surface of the wall. The high friction material may be constructed and arranged as a friction layer having a rough or textured surface and may include materials such as, but not limited to, wool, corduroy, fleece, hook-and-loop textiles, denim, towel, leather, polyvinyl chloride (PVC), or polyurethane (PU). The high friction material may be constructed and arranged to create resistance to movement of the sheet grip when the sheet grip is positioned between a box-spring and mattress, or mattress and bed frame, mattress and floor, or other mattress and bedding arrangement. The sheet grip may be positioned partially below a mattress and inside of a bed sheet or may be positioned on top of a bed sheet to prevent bed sheets from coming off a mattress or bedding.

The sheet grip may be constructed and arranged to prevent elastic-trimmed sheets from slipping off mattress corners.

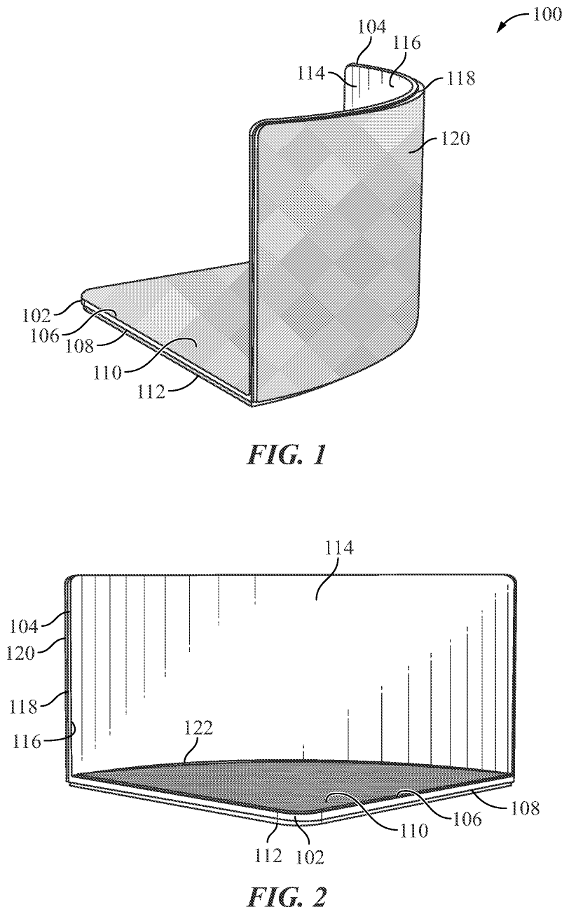

Referring to FIGS. 1 and 2, a sheet grip 100 may include a base 102 having a first base surface 106 opposite a second base surface 108. The base 102 may be generally circular sector shaped. A first friction layer 110 may be disposed on the first base surface 106. A second friction layer 112 may be disposed on the second base surface 108.

The sheet grip 100 may include a generally curved wall 104 have a first wall surface 116 opposite a second wall surface 118. The wall 104 may be attached or integrated with the base 102 at interface 122. A third friction layer 114 may be disposed on the first wall surface 116. A fourth friction layer 120 may be disposed on the second wall surface 118.

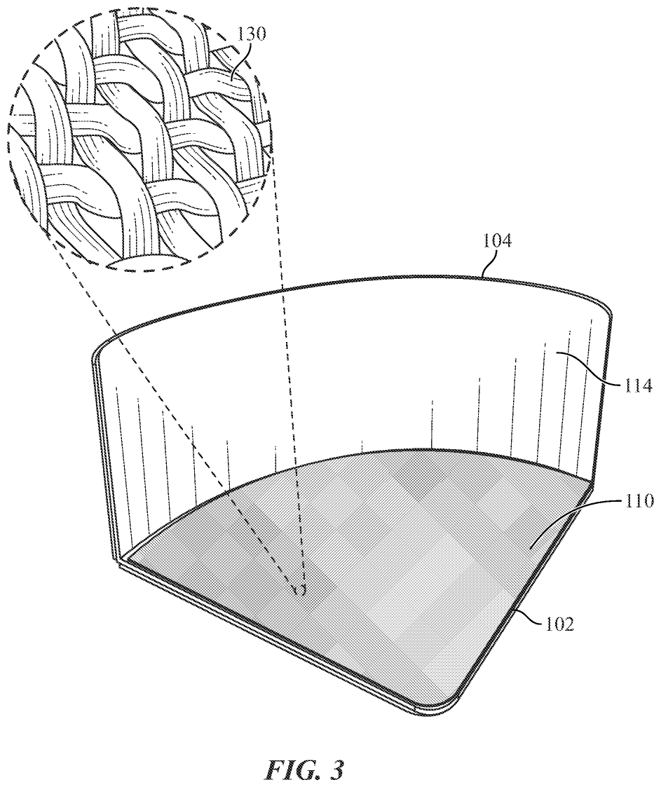

Referring to FIG. 3, a sheet grip may include a base 102 and wall 104, having a first friction layer 110 and third friction layer 114, respectively. Any of the first friction layer 110, second friction layer 112, third friction layer 114, or fourth friction layer 120 may include a friction generating material 130.

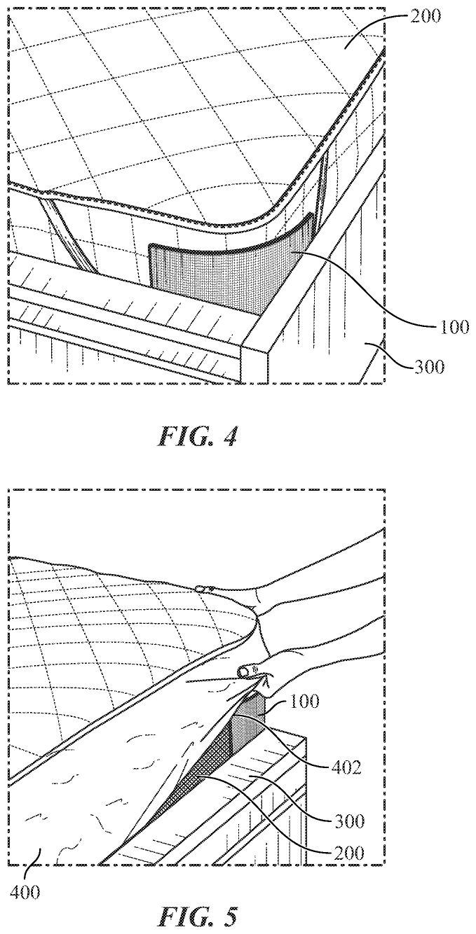

Referring to FIGS. 4 and 5, a sheet grip 100 may be positioned below a mattress 200 or similar padding or bedding, and on top of a frame 300 or similar structure such as a box spring, floor, or bed frame. A sheet 402, such as a fitted sheet, may be positioned on the mattress 200 and substantially over the sheet grip 100. Each of the first friction layer 110, second friction layer 112, third friction layer 114, and fourth friction layer 120 may prevent movement of the mattress 200, sheet 402, and frame 300.

The following description of variants is only illustrative of components, elements, acts, product, and methods considered to be within the scope of the disclosure and are not in any way intended to limit such scope by what is specifically disclosed or not expressly set forth. The components, elements, acts, product, and methods as described herein may be combined and rearranged other than as expressly described herein and still are within the scope of the invention.

According to variation 1, a sheet grip may include a base including a first base surface opposite a second base surface; a first friction layer disposed on the first base surface; a second friction layer disposed on the second base surface; a wall including a first wall surface opposite a second wall surface; a third friction layer disposed on the first wall surface; and a fourth friction layer disposed on the second wall surface.

Variation 2 may include a sheet grip as in variation 1, wherein at least one of the first friction layer, second friction layer, third friction layer, or fourth friction layer include a friction generating material.

Variation 3 may include a sheet grip as in variation 1 or 2, wherein each of the first friction layer, second friction layer, third friction layer, or fourth friction layer include a friction generating material.

Variation 4 may include a sheet grip as in any of variations 1 through 3, wherein the base is generally circular sector shaped.

Variation 5 may include a sheet grip as in any of variations 1 through 4, wherein the wall is attached or integrated with the base at interface.

Variation 6 may include a sheet grip as in any of variations 1 through 5, wherein the wall is generally curved.

Variation 7 may include a sheet grip as in any of variations 1 through 6, wherein at least one of the first friction layer, second friction layer, third friction layer, or fourth friction layer include at least one of wool, corduroy, fleece, hook-and-loop textiles, denim, towel, leather, polyvinyl chloride (PVC), or polyurethane (PU).

Variation 8 may include a sheet grip as in any of variations 1 through 7, wherein each of the first friction layer, second friction layer, third friction layer, or fourth friction layer include at least one of wool, corduroy, fleece, hook-and-loop textiles, denim, towel, leather, polyvinyl chloride (PVC), or polyurethane (PU).

According to variation 9, a sheet grip may include a generally circular sector shaped base including a first base surface opposite a second base surface; a first friction layer including a friction generating material disposed on the first base surface; a second friction layer including a friction generating material disposed on the second base surface; a wall including a first wall surface opposite a second wall surface; a third friction layer including a friction generating material disposed on the first wall surface; and a fourth friction layer including a friction generating material disposed on the second wall surface.

Variation 10 may include a sheet grip as in variation 9, wherein the wall is attached or integrated with the base at interface.

Variation 11 may include a sheet grip as in variations 9 or 10, wherein the wall is generally curved.

Variation 12 may include a sheet grip as in any of variations 9 through 11, wherein at least one of the first friction layer, second friction layer, third friction layer, or fourth friction layer include at least one of wool, corduroy, fleece, hook-and-loop textiles, denim, towel, leather, polyvinyl chloride (PVC), or polyurethane (PU).

Variation 13 may include a sheet grip as in any of variations 9 through 12, wherein each of the first friction layer, second friction layer, third friction layer, or fourth friction layer include at least one of wool, corduroy, fleece, hook-and-loop textiles, denim, towel, leather, polyvinyl chloride (PVC), or polyurethane (PU).

Variation 14 may include a sheet grip as in any of variations 9 through 13, wherein the base includes a semi-rigid plastic.

Variation 15 may include a sheet grip as in any of variations 9 through 14, wherein the wall includes a semi-rigid plastic.

According to variation 16, a sheet grip may include a generally circular sector shaped base including a first base surface opposite a second base surface; a first friction layer including a friction generating material disposed on the first base surface; a second friction layer including a friction generating material disposed on the second base surface; a generally curved wall fixed to the base, the generally curved wall including a first wall surface opposite a second wall surface; a third friction layer including a friction generating material disposed on the first wall surface; and a fourth friction layer including a friction generating material disposed on the second wall surface.

Variation 17 may include sheet grip as in variation 16, wherein at least one of the first friction layer, second friction layer, third friction layer, or fourth friction layer include at least one of wool, corduroy, fleece, hook-and-loop textiles, denim, towel, leather, polyvinyl chloride (PVC), or polyurethane (PU).

Variation 18 may include a sheet grip as in variation 16 or 17, wherein each of the first friction layer, second friction layer, third friction layer, or fourth friction layer include at least one of wool, corduroy, fleece, hook-and-loop textiles, denim, towel, leather, polyvinyl chloride (PVC), or polyurethane (PU).

Variation 19 may include a sheet grip as in any of variations 16 through 18, wherein the base includes a semi-rigid plastic.

Variation 20 may include a sheet grip as in any of variations 16 through 19, wherein the wall includes a semi-rigid plastic.

Several different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

I/We claim:

1. A sheet grip, comprising:
a base comprising a first base surface opposite a second base surface;
a first friction layer disposed on the first base surface;
a second friction layer disposed on the second base surface;
a wall comprising a first wall surface opposite a second wall surface;
a third friction layer disposed on the first wall surface; and
a fourth friction layer disposed on the second wall surface.

2. A sheet grip as in claim 1, wherein at least one of the first friction layer, second friction layer, third friction layer, or fourth friction layer comprise a friction generating material.

3. A sheet grip as in claim 1, wherein each of the first friction layer, second friction layer, third friction layer, or fourth friction layer comprise a friction generating material.

4. A sheet grip as in claim 1, wherein the base is generally circular sector shaped.

5. A sheet grip as in claim 1, wherein the wall is attached or integrated with the base at interface.

6. A sheet grip as in claim 1, wherein the wall is generally curved.

7. A sheet grip as in claim 1, wherein at least one of the first friction layer, second friction layer, third friction layer, or fourth friction layer comprise at least one of wool, corduroy, fleece, hook-and-loop textiles, denim, towel, leather, polyvinyl chloride (PVC), or polyurethane (PU).

8. A sheet grip as in claim 1, wherein each of the first friction layer, second friction layer, third friction layer, or fourth friction layer comprise at least one of wool, corduroy, fleece, hook-and-loop textiles, denim, towel, leather, polyvinyl chloride (PVC), or polyurethane (PU).

9. A sheet grip, comprising:
a generally circular sector shaped base comprising a first base surface opposite a second base surface;
a first friction layer comprising a friction generating material disposed on the first base surface;
a second friction layer comprising a friction generating material disposed on the second base surface;
a wall comprising a first wall surface opposite a second wall surface;
a third friction layer comprising a friction generating material disposed on the first wall surface; and
a fourth friction layer comprising a friction generating material disposed on the second wall surface.

10. A sheet grip as in claim 9, wherein the wall is attached or integrated with the base at interface.

11. A sheet grip as in claim 9, wherein the wall is generally curved.

12. A sheet grip as in claim 9, wherein at least one of the first friction layer, second friction layer, third friction layer, or fourth friction layer comprise at least one of wool, corduroy, fleece, hook-and-loop textiles, denim, towel, leather, polyvinyl chloride (PVC), or polyurethane (PU).

13. A sheet grip as in claim 9, wherein each of the first friction layer, second friction layer, third friction layer, or fourth friction layer comprise at least one of wool, corduroy, fleece, hook-and-loop textiles, denim, towel, leather, polyvinyl chloride (PVC), or polyurethane (PU).

14. A sheet grip as in claim 9, wherein the base comprises a semi-rigid plastic.

15. A sheet grip as in claim 9, wherein the wall comprises a semi-rigid plastic.

16. A sheet grip, comprising:
a generally circular sector shaped base comprising a first base surface opposite a second base surface;
a first friction layer comprising a friction generating material disposed on the first base surface;
a second friction layer comprising a friction generating material disposed on the second base surface;
a generally curved wall fixed to the base, the generally curved wall comprising a first wall surface opposite a second wall surface;
a third friction layer comprising a friction generating material disposed on the first wall surface; and
a fourth friction layer comprising a friction generating material disposed on the second wall surface.

17. A sheet grip as in claim 16, wherein at least one of the first friction layer, second friction layer, third friction layer, or fourth friction layer comprise at least one of wool, corduroy, fleece, hook-and-loop textiles, denim, towel, leather, polyvinyl chloride (PVC), or polyurethane (PU).

18. A sheet grip as in claim 16, wherein each of the first friction layer, second friction layer, third friction layer, or fourth friction layer comprise at least one of wool, corduroy, fleece, hook-and-loop textiles, denim, towel, leather, polyvinyl chloride (PVC), or polyurethane (PU).

19. A sheet grip as in claim 16, wherein the base comprises a semi-rigid plastic.

20. A sheet grip as in claim 16, wherein the wall comprises a semi-rigid plastic.
